(19) United States
(12) Patent Application Publication
(10) Pub. No.: US 2013/0089182 A1
(43) Pub. Date: Apr. 11, 2013

(54) Evaluation System and Evaluation Method of Plastic Strain

(71) Applicant: Hitachi, Ltd., Tokyo (JP)

(72) Inventors: Yun WANG, Hitachi-shi (JP); Ryo Ishibashi, Tokai-mura (JP); Junya Kaneda, Hitachi-shi (JP); Yusaku Maruno, Tokai-mura (JP); Masato Koshiishi, Takahagi-shi (JP)

(73) Assignee: Hitachi, Ltd., Tokyo (JP)

(21) Appl. No.: 13/648,930

(22) Filed: Oct. 10, 2012

(30) Foreign Application Priority Data
Oct. 11, 2011 (JP) 2011-224130

(51) Int. Cl. G01N 23/20; G01N 23/203

(52) U.S. Cl. 378/72

(57) ABSTRACT

An evaluation system for plastic strain includes an X-ray diffraction device for irradiating the surface of a measurement object; and an image analyzing device that generates diffraction intensity curves from X-ray diffraction angle and intensity with an implanted database, which can be obtained in advance from test specimens made of the same material of the measurement object, establishing at least one of the relations between the full width at half maximum of the diffraction intensity curve and plastic strain, and between the integral intensity angular breadth of diffraction intensity curve and plastic strain. The image analyzing device obtains plastic strain of the measurement object based on at least one of the diffraction parameters of the full width at half maximum and the integral intensity angular breadth of a diffraction intensity curve corresponding to the implanted database indicative of the relation between the diffraction parameter and plastic strain.

### CLAIM OF PRIORITY

The present application claims priority from Japanese Patent Application JP 2011-224130 filed on Oct. 11, 2011, the content of which is hereby incorporated by reference into this application.

### FIELD OF THE INVENTION

The present invention relates to an evaluation system of plastic strain and an evaluation method thereof, and more specifically to a non-destructive evaluation system and method of plastic strain, which utilize an X-ray diffraction phenomenon.

### BACKGROUND OF THE INVENTION

Plastic strain generally remains in the surface of a structure due to treating histories of grinding, polishing and the like. Plastic strain is used as an index for reflecting the degree of treatment when the finishing state of the surface of the structure is evaluated. Particularly in the case of a structure activated in a stress corrosion environment, it is known that the sensitivity of generation of stress corrosion cracking (SCC) increases as a degree of treatment of the surface is higher. It has been suggested that a plastic deformation band and surface fine crystalline texture formed by surface treatment can be an origin of generation of SCC or its growth path.

In the case of a polycrystalline metal material, dislocation and a shear slip are restrained in a grain boundary and difference in orientations occurs in crystal grains when plastic deformation occurs. Conventional studies have discussed the effectiveness of using local misorientation parameters of electron backscattering diffraction (EBSD) method in the evaluation of plastic strain. For example, the effectiveness of representing plastic strain by local misorientation parameters such as KAM (Kernel Average Misorientation) and GROD (Grain Reference Orientation Deviation) has been verified.

KAM is an average value of differences in orientations (misorientations) between a given measurement point and a measurement point adjacent thereto, and enables detection of misorientation of a fine part. This, however, depends on the distance between adjacent measurement points, i.e., a set value of a measurement step. Therefore, if measurement conditions differ, the obtained value of KAM is not necessarily constant even though in the same measurement spot.

GROD is a parameter used to obtain an average orientation in the same crystal grain and indicate a misorientation between a measurement point and an average orientation of a crystal. The misorientation between the measurement point and the average orientation of the crystal is defined as GROD at this measurement point within the same crystal grain. The average orientation of the crystal is defined as the orientation average value of all measurement points or the orientation of the measurement point having the minimum KAM value within the same crystal grain. Since GROD indicates the crystal misorientation with respect to the average crystal orientation instead of the adjacent measurement point, higher reliability is expected without depending on the setting of the measurement step. The details of GROD are described in “Mechanism of Compressive Residual Stress Introduction on Surfaces of Metal Materials by Water-Jet Peening” (R. Ishibashi, H. Hato and F. Yoshikubo, Proceedings of the ASME 2010 Pressure Vessels & Piping Division, PVP2010 Washington, USA (2010))

The EBSD analysis, which is conducted in a sample chamber of an SEM, requires a measuring sample cut from the measurement object. That is, the EBSD method is a destructive analysis method.

When actual structures or large parts are measured, a non-destructive method is required. An X-ray diffraction method is applied, as a non-destructive measuring method, to various material evaluations such as a crystal structure analysis, a componential analysis and a residual stress measurement, etc. The X-ray diffraction method is a method using a phenomenon that, when incident X-ray is applied onto each lattice plane in which atoms are regularly arranged inside a crystal material, the reflected X-ray is interfered and added to each other if the difference in optical paths between different lattice planes is equal to the integral multiple of the wavelength of X-ray.

Conventionally, a goniometer, a zero-dimensional scintillation counter (SC) or a one-dimensional position sensitive detector (PSD) has been used for recording diffraction angle and intensities of diffracted X-ray.

Recently, research and development have been pursued for an X-ray diffraction device provided with a two-dimensional detector capable of acquiring a wide range of diffraction information in a short period of time. Examples of such studies include an application of a two-dimensional position sensitive proportional counter (PSPC) or a photostimulable phosphor typified by an imaging plate (IP) to a two-dimensional detector.

The imaging plate is a film coated with a photostimulable phosphor (BaFX: Eu2+, X=Br, I). When the imaging plate is irradiated with X-ray, a kind of metastable color center is formed in a phosphor. Thereafter, when laser light is applied to the phosphor by a reader, X-ray energy accumulated in the phosphor is emitted as fluorescence. If laser is two-dimensionally scanned on the surface of the phosphor and the generated fluorescence is measured as a time series signal by a photomultiplier, X-ray information recorded on the surface of the phosphor can be read. The imaging plate can be repeatedly used because the color center is erased when the imaging plate is exposed to visible light.

Several techniques have been disclosed about the non-destructive detection of the quality of a material, which make use of EBSD method or X-ray diffraction parameters such as the full width at half maximum (FWHM) of X-ray diffraction intensity curve.

Japanese Patent No. 2615064 discloses a method for evaluating a change in crystallinity in the depth direction from the surface of a crystal using the X-ray diffraction method to thereby evaluate the crystallinity of a crystal surface layer. X-ray is applied to the crystal with the X-ray penetration depth continuously changed so as to satisfy diffraction conditions relative to one crystal lattice plane of the crystal. With this, the plane interval and full width at half maximum of the diffraction peak in X-ray diffraction intensity curve about the crystal lattice plane or the amount of change in full width at half maximum at a locking curve is evaluated. However, application about evaluation of plastic strain in the surface is not discussed.

Japanese Patent Application Laid-Open Publication No. 2011-033600 discloses a technique for conducting a delayed fracture hydrogen-amount estimating process, which, upon evaluation of resistance to delayed fracture of a molded product of steel plates, obtains the amount of hydrogen corresponding to strain of crystals within the evaluation region of the molded product of steel plates by using the relation in which the amount of hydrogen and strain of crystals of steel at the time the delayed fracture occurs are associated with each other, thereby estimating the amount of hydrogen that allows the evaluation region to generate the delayed fracture. The local misorientation parameter KAM of EBSD method and the full width at half maximum of an X-ray diffraction peak are used upon evaluation of strain of each crystal

Conventionally, studies have been conducted which use the correlation between the local misorientation parameter KAM of EBSD method and plastic strain with respect to the evaluation of plastic strain of a measured part. However, EBSD method, which is a destructive analysis method, cannot be applied to cases where a non-destructive method is required for actual structures, production parts, and so on.

As a non-destructive method, a method of evaluating lattice strain and dislocation densities from the full width at half maximum of X-ray diffraction intensity curve or the spread of the diffraction spots has been proposed. The lattice strain is obtained by dividing a change in plane interval by lattice plane interval in a non-strain state. Plastic strain is permanent strain formed by generation of dislocation and a shear slip. According to the Willamson-Hall method, for example, the lattice strain can be non-destructively evaluated if the full width at half maximum is measured because the full width at half maximum of X-ray diffraction intensity curve is affected by a crystal size and lattice strain. However, the correlation between the lattice strain and plastic strain is not sufficiently clarified.

Several devices and methods have also been proposed which evaluate plastic strain of the surface of a structure by hardness measurement by using a phenomenon that hardness increases due to work hardening. However, they are not non-destructive methods because impressions remain in the measurement part.

The purpose of the present invention is to provide a system and method for evaluating plastic strain on the surface of the measurement object in a non-destructive manner.

### SUMMARY OF THE INVENTION

One aspect of an evaluation system of plastic strain according to the present invention has the following basic features.

An evaluation system of plastic strain includes X-ray diffraction devices for irradiating the surface of the measurement object with X-ray and measuring diffraction angle and X-ray diffraction intensity; and an image analyzing device which obtains X-ray diffraction intensity curve, wherein the image analyzing device is implanted with a data base indicative of at least one of the relations between the full width at half maximum of X-ray diffraction intensity curve and plastic strain, and between the integral intensity angular breadth of X-ray diffraction intensity curve and plastic strain, the relations being obtained in advance using test specimens made of the same material of the measurement object. The image analyzing device evaluates plastic strain from at least one of the diffraction parameters such as the full width at half maximum or the integral intensity angular breadth of X-ray diffraction intensity curve of the measurement object corresponding to the data base indicating relations between the these parameters and plastic strain.

According to the present invention, plastic strain of the surface of the measurement object can be evaluated in a non-destructive manner.

### BRIEF DESCRIPTION OF THE DRAWINGS

FIG. 1 is a flow diagram of a method for non-destructively evaluating plastic strain of a treated surface layer of the measurement object;

FIG. 2 is a view showing one example of a correlation diagram between the local misorientation parameter GROD of EBSD method and plastic strain ε_{P};

FIG. 3 is a schematic view of an optical system for measuring X-ray diffraction intensity by a scintillation proportional counter;

FIG. 4 is a schematic view of an optical system for measuring X-ray diffraction intensity by an IP two-dimensional detector;

FIG. 5 is a schematic view showing the radial width S_{R} of a Debye ring;

FIG. 6 is a schematic view illustrating an EBSD measurement region of the measurement object;

FIG. 7 is a correlation diagram between the local misorientation parameter GROD and plastic strain ε_{P} in a first embodiment;

FIG. 8 is a photograph of a Debye ring, which is recorded on an imaging plate in the first embodiment;

FIG. 9 is a master diagram showing the relation between the full width at half maximum B₁ and plastic strain ε_{P} in the first embodiment;

FIG. 10 is a master diagram showing the relation between the full width at half maximum B₁ and plastic strain ε_{P} in a second embodiment; and

FIG. 11 is a schematic diagram showing a configuration of an evaluation system of plastic strain in the embodiments of the present invention.

### DETAILED DESCRIPTION OF THE PREFERRED EMBODIMENTS

The present invention provides a system and a method which create in advance a master diagram for expressing a relation between an X-ray diffraction parameter and plastic strain with a function, and non-destructively evaluate plastic strain with the master diagram as an evaluation criterion. The master diagram can also be created based on a correlation between an X-ray diffraction parameter and the local misorientation parameter GROD of EBSD method and a correlation between plastic strain and GROD.

That is, in the present invention, a functional relation between an X-ray diffraction parameter of a metal material (test specimen) obtained in different treating conditions and GROD, and a functional relation between plastic strain introduced by an uniaxial tensile test and GROD are constructed to thereby create a master diagram showing the relation between an X-ray diffraction parameter and plastic strain. As the X-ray diffraction parameter, at least one of the full width at half maximum B₁, the integral intensity angular breadth B₂, and the radial width (difference between an outer radius and an inner radius) S_{R} of two-dimensional diffraction patterns may be used.

When the measurement object is actually measured, an X-ray diffraction parameter obtained from the surface of the object is plotted on the master diagram, thereby making it possible to non-destructively evaluate plastic strain of the surface of the object.

The detectability of X-ray diffraction generally varies according to grain size and microscopic structure of the measurement object. In the case of a weld metal having coarse and textured crystals, for example, the number of diffraction planes in an X-ray irradiation region is not so sufficient that X-ray diffraction intensity is reduced. The present invention can be applied even to a material like the weld metal, having coarse and textured crystals, by selecting a scintillation proportional counter or a two-dimensional detector according to the crystalline properties of a material and by measuring X-ray diffraction intensity.

A best mode of the present invention will be described below in detail. In the following description and embodiments, the correlation between plastic strain ε_{P} and GROD and the correlations between X-ray diffraction parameters (full width at half maximum B₁, the integral intensity angular breadth B₂ and the radial width S_{R} of two-dimensional diffraction patterns) and GROD are approximately expressed with functions using the method of least squares. In the present invention, however, the approximation method is not limited to the method of least squares, and any approximation method can be used. A function indicative of the correlation between plastic strain ε_{P} and GROD, a function indicative of the correlation between an X-ray diffraction parameter and GROD, and a function indicative of the correlation between an X-ray diffraction parameter and plastic strain ε_{P} are not limited to those shown in the following description and embodiments. These correlations can be represented in the form of arbitrary functions. When it is not possible to formulate these correlations, the correlations are represented by data of sequence of points (the functions are expressed by data of sequence of points). In this case, plastic strain ε_{P} can be evaluated using a correlation diagram or a master diagram indicating these correlations. In the present specification, the correlation represented by data of sequence of points is also referred to as a “function.”

FIG. 11 is a schematic diagram showing a configuration of an evaluation system of plastic strain in embodiments of the present invention. The evaluation system of plastic strain in the embodiments includes an X-ray diffraction device 100, and an image analyzing device 110 which performs analysis such as image processing and a numerical calculation.

The X-ray diffraction device 100 includes an X-ray tube 101 and an X-ray detector 102. The X-ray diffraction device 100 irradiates the surface of an object 104 to be measured with X-ray and measures diffraction angle and X-ray diffraction intensity.

The image analyzing device 110 can acquire X-ray diffraction intensity curves 111 from diffraction angle and X-ray diffraction intensity. When the X-ray detector 102 of the X-ray diffraction device 100 is a two-dimensional detector, the image analyzing device 110 can also obtain two-dimensional diffraction patterns. The image analyzing device 110 can obtain X-ray diffraction parameters (the full width at half maximum B₁, the integral intensity angular breadth B₂ and the radial width S_{R} on two-dimensional diffraction patterns) from X-ray diffraction intensity curve 111 or two-dimensional diffraction patterns by using analysis programs. Further, the image analyzing device 110 can hold data about the relation between the X-ray diffraction parameters of the object 104 and its plastic strain and obtain plastic strain of the object 104 from the data and X-ray diffraction parameters obtained by measuring the object 104 by the X-ray diffraction device 100. The data about the relation between the X-ray diffraction parameters of the object 104 and its plastic strain can be obtained in advance using the X-ray diffraction device 100 and the image analyzing device 110.

The evaluation system of plastic strain in the embodiments may include an electron backscattering diffraction device 120. The electron backscattering diffraction device 120 can acquire data about the relation between the local misorientation parameter GROD of the object 104 to be measured and its plastic strain. The image analyzing device 110 is able to hold the data about the relation between GROD of the object 104 and its plastic strain therein.

The image analyzing device 110 is capable of obtaining data about the relation between X-ray diffraction parameters and plastic strain from the data about the relation between GROD of the object 104 and its plastic strain and from the data about the relation between the X-ray diffraction parameters and GROD. The data about the relation between the X-ray diffraction parameters and GROD can be obtained in advance by using the X-ray diffraction device 100, the electron backscattering diffraction device 120 and the image analyzing device 110. Plastic strain of the object 104 to be measured can be obtained from the data about the relation between the X-ray diffraction parameters and plastic strain and from the X-ray diffraction parameters obtained by measuring the object 104 by the X-ray diffraction device 100.

The image analyzing device 110 can also represent the relation between the X-ray diffraction parameters of the object 104 and its plastic strain by a function or a diagram. The relation between GROD of the object 104 and its plastic strain and the relation between the X-ray diffraction parameters and GROD can also be represented by functions or diagrams.

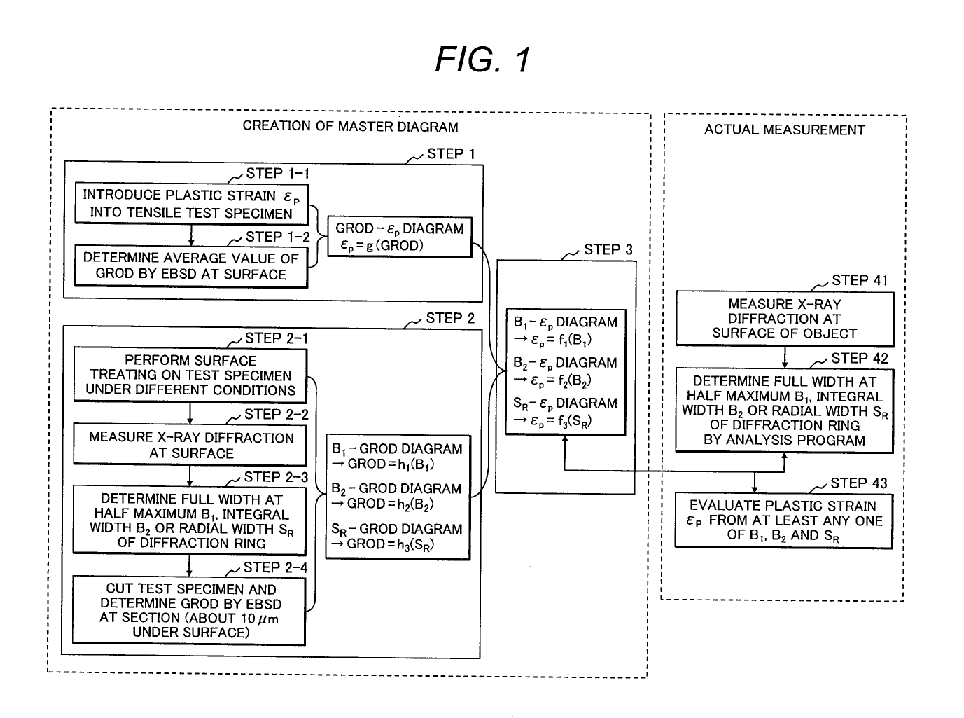

FIG. 1 is a flow diagram of a method for non-destructively evaluating plastic strain of a treated surface layer of the measurement object in an embodiment of the present invention. This flow diagram is divided into two parts, i.e., “creation of master diagram” and “actual measurement”. In the “creation of master diagram,” a master diagram is created. In the “actual measurement,” plastic strain of the object is evaluated using X-ray diffraction parameters obtained by an X-ray diffraction method and the created master diagram. Although there are plural methods for creating the master diagram, one of them is shown in FIG. 1. The method shown in FIG. 1 will be explained below as a “Procedure for Creating Master Diagram (Part 1)” Another method for creating a master diagram will be explained later as a “Procedure for Creating Master Diagram (Part 2)”.

1. Procedure for Creating Master Diagram (Part 1)

As a procedure for creating the master diagram, a procedure for expressing the correlation between an X-ray diffraction parameter and plastic strain with a function will be explained. The master diagram expresses the correlation between an X-ray diffraction parameter and plastic strain with a function. Thus, the relation between an X-ray diffraction parameter and plastic strain is obtained to create a master diagram. The procedure for creating the master diagram is roughly divided into three procedures, i.e., expressing a relation between the local misorientation parameter GROD of EBSD method and plastic strain with a function, expressing a relation between an X-ray diffraction parameter and GROD with a function, and expressing a relation between an X-ray diffraction parameter and plastic strain with a function.

1.1 Expressing a Relation Between GROD and Plastic Strain with a Function

Step 1 in FIG. 1 shows a procedure for expressing a relation between the local misorientation parameter GROD of EBSD method and plastic strain ε_{P} with a function and creating a correlation diagram (GROD-ε_{P} diagram) showing a relation between GROD and plastic strain ε_{P}. Since the correlation between GROD and plastic strain ε_{P} differs due to difference in physical property of the material, GROD-ε_{P} diagram is created for each test specimen of plural types different in material.

At Step 1-1, plastic strain ε_{P} is introduced into a test specimen. For example, a test specimen is produced from a material similar to the measurement object, and a tensile test is conducted thereon to introduce plastic strain ε_{P} under strain control.

At Step 1-2, an EBSD analysis is performed on the surface of test specimens with plastic strain ε_{P} introduced therein, and the average value of GROD in a measurement region is calculated. The size of the measurement region is preferably set in such a manner that a several hundreds of crystals or more are contained in the measurement region. This is because the measurement region needs a sufficient number of analysis crystals to reduce the effects of measurement spots and crystal orientations.

After the EBSD analysis, the procedure returns to Step 1-1, where different plastic strains ε_{P} are introduced into test specimens. At Step 1-2, the EBSD analysis is conducted again to calculate the average value of GROD in the measurement region. Thus, GROD relative to the introduced plastic strain ε_{P} is obtained by repeating Step 1-1 and Step 1-2.

The respective correlations between plastic strain ε_{P} and GROD are approximated by the method of least squares to create a GROD-ε_{P} diagram. If, for example, the correlation between plastic strain ε_{P} and GROD is expressed with a linear function g, plastic strain ε_{P} is expressed in the following equation:

ε_{P}=g(GROD)=A·GROD+C

where constants A and C are approximately determined by the method of least squares. The correlation between plastic strain ε_{P} and GROD may be expressed with a function other than the linear function.

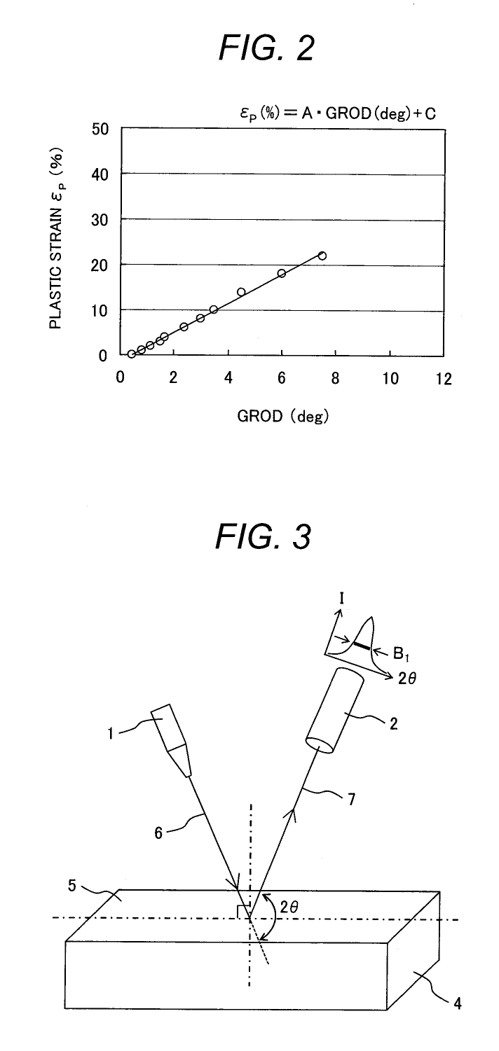

FIG. 2 is a view showing one example of a correlation diagram (GROD-ε_{P} diagram) between the local misorientation parameter GROD of EBSD method and plastic strain ε_{P}. In FIG. 2, the relation between plastic strain ε_{P} and GROD is expressed by a linear relation of ε_{P}=A·GROD+C.

It is desirable that the creation of test specimens and the conditions for the tensile test comply with the standard of JIS Z 2241 (1988) in order to take into consideration the validity of the tensile test. In order to take into consideration variations in test specimens, it is preferable to create plural test specimens from the same material, to introduce plastic strain into the respective test specimens in a tensile test, and thereafter to obtain GROD by the EBSD analysis.

When plastic strain is introduced by surface treatment, plastic strain varies in a wide range depending on treating conditions. Therefore, Step 1-1 and Step 1-2 in FIG. 1 (introduction of plastic strain and calculation of GROD) may be conducted until each test specimen fractures. Since the reliability of data is decreased with the generation of projections and depressions of the surface of test specimens and dislocation densities in the EBSD analysis, the sensitivity of GROD to plastic strain is generally high in a range small in plastic strain. It is therefore desirable that the interval of plastic strain is set relatively narrower at a level small in plastic strain than at a level large in plastic strain. For example, plastic strain is introduced into test specimens at 1-2% interval in the case where plastic strain is from 0% to 10%, and at 4-5% interval in the case where plastic strain is from 10% to 20%, respectively. It is necessary to set the interval of plastic strain according to actual materials since the range of plastic strain is different according to the physical properties of materials.

1.2 Expressing a Relation Between an X-Ray Diffraction Parameter and GROD with a Function

Step 2 in FIG. 1 shows a procedure for expressing the relation between an X-ray diffraction parameter and the local misorientation parameter GROD of EBSD method with a function and creating a correlation diagram (B₁-GROD diagram, B₂-GROD diagram or S_{R}-GROD diagram) showing the relation between an X-ray diffraction parameter and GROD. At Step 2, plural test specimens are produced from the same material as the test specimens used at Step 1. The relation between an X-ray diffraction parameter and GROD is obtained using each of the test specimens.

At Step 2-1, surface treating is performed on test specimens under treating conditions different in the degree of treatment such as emery paper polishing and grinder polishing. This Step is performed to obtain X-ray diffraction intensity curves with respect to treating conditions which can be set because plastic strain varies depending on the treating conditions of the surface.

At Step 2-2, the treating surface of test specimens is irradiated with X-ray and X-ray diffraction intensity and diffraction angle 2θ are measured by the X-ray detector. The X-ray diffraction intensity curve is obtained from the measured X-ray diffraction intensity and diffraction angle 2θ.

At Step 2-3, a background is subtracted from the obtained X-ray diffraction intensity curve, X-ray diffraction intensity curve being approximately expressed with a function, and the full width at half maximum B₁ (difference in diffraction angles of two points at a level equivalent to half the maximum value of the X-ray diffraction intensity) being decided. At this time, the integral value B₂ (value obtained by dividing an integrated intensity by a peak intensity) can also be obtained. When the X-ray diffraction intensity is measured by a two-dimensional detector, the radial width S_{R} of two-dimensional diffraction patterns can also be obtained. The full width at half maximum B₁, the integral intensity angular breadth B₂ and the radial width S_{R} of two-dimensional diffraction patterns are X-ray diffraction parameters.

The full width at half maximum B₁ can be estimated by function approximation such as Gaussian curve, Lorenz curve and pseudo-Voigt function.

The X-ray diffraction intensity curve I_{G} approximately expressed with the Gaussian curve is represented in the following equation (1), and the integral intensity angular breadth B₂ is obtained from the following equations (2) and (3):

$$\begin{matrix}{I}_{G} ( 2 θ ) = \frac{2 J}{{B}_{1}} \sqrt{\frac{ln ( 2 )}{π}} exp [ - 4 ln ( 2 ) ( \frac{2 θ - 2 {θ}_{Ψ}}{{B}_{1}} ) ] & ( 1 ) \\ {B}_{2} = \frac{J}{{I}_{max}} & ( 2 ) \\ {I}_{max} = \frac{2 J}{{B}_{1}} \sqrt{\frac{ln ( 2 )}{π}} & ( 3 )\end{matrix}$$

where J is an integrated intensity, 2θ_{Ψ} is a peak position, and Iₘₐₓ is a peak intensity.

The X-ray diffraction intensity curve I_{L} approximately expressed with the Lorenz curve is represented in the following equation (4), and the integral intensity angular breadth B₂ is obtained from the following equations (5) and (6):

$$\begin{matrix}{I}_{L} ( 2 θ ) = \frac{2 J}{{B}_{1}} \frac{{B}_{1}}{4 {( 2 θ - 2 {θ}_{Ψ} )}^{2} + {B}_{1}^{2}} & ( 4 ) \\ {B}_{2} = \frac{J}{{I}_{max}} & ( 5 ) \\ {I}_{max} = \frac{2 J}{{B}_{1}} & ( 6 )\end{matrix}$$

where J is an integrated intensity, 2θ_{Ψ} is a peak position, and Iₘₐₓ is a peak intensity.

The X-ray diffraction intensity curve Iᵥ approximately expressed with the pseudo Voigt function is represented in the following equation (7) using I_{G} and I_{L}:

I_{V}(2θ)=η·I_{G}(2θ)+(1−η)·I_{L}(2θ) (7)

where η denotes a Gauss degree.

FIG. 3 is a schematic view of an optical system for measuring the X-ray diffraction intensity I by a scintillation proportional counter in the X-ray diffraction device. The surface 5 of the measurement object 4 is irradiated with an incident X-ray 6 from an X-ray tube 1. The X-ray 6 applied onto the treating surface 5 is diffracted at diffraction angle 2θ, resulting in a diffracted X-ray 7. The diffracted X-ray 7 is detected by the scintillation proportional counter 2.

In the case of a general structural material like carbon steel, which possesses grains with size of equal to or less than a few tens of μm and does not have aggregate texture, the full width at half maximum B₁ and the integral intensity angular breadth B₂ can be obtained with satisfactory accuracy by using a zero-dimensional scintillation counter or a one-dimensional position sensitive detector. Generally, a treated surface layer exists even up to a few hundred of μm under the surface. However, X-ray can only obtain diffraction information about a top surface due to the effects of the output of a generation device and absorption by the material. In order to obtain diffraction information at a deeper spot, it is preferable to rotatably scan the X-ray tube and the detector while holding an angle Ψ=0° between the normal line of the diffraction plane and the normal line of the sample surface, i.e., holding the normal line of the diffraction plane and the surface of the sample perpendicular to each other.

In the case of a material like a weld metal, which possesses coarse and textured crystals, it is desirable to use a two-dimensional detector capable of obtaining omnidirectional X-ray diffraction information in one measurement because the material has a directional property upon X-ray diffraction detection.

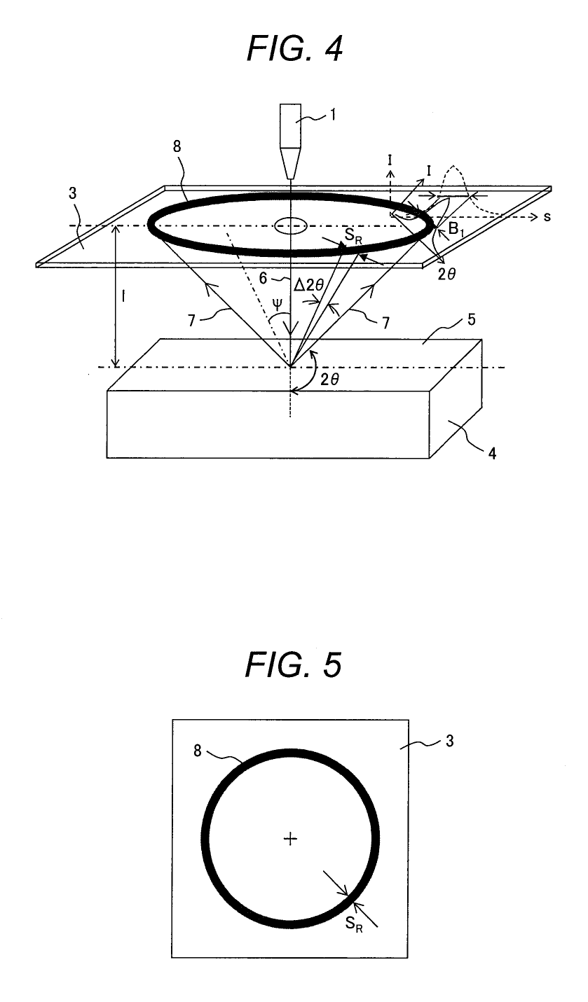

FIG. 4 is a schematic view of an optical system for measuring X-ray diffraction intensity by a two-dimensional detector (IP two-dimensional detector) of an imaging plate type in the X-ray diffraction device. An incident X-ray 6 from an X-ray tube 1 is applied onto a measured plane (The surface 5 of the measurement object 4) vertically from a circular hole located in the center of the IP two-dimensional detector 3. Each X-ray 7 diffracted at diffraction angle 2θ is detected by the IP two-dimensional detector 3. A ring-shaped diffraction pattern, i.e., the two-dimensional diffraction patterns (Debye ring 8) is recorded in the IP two-dimensional detector 3. The radial width S_{R} of the Debye ring 8 is a difference between the outer radius of the Debye ring 8 and the inner radius thereof, being an X-ray diffraction parameter.

It is preferable to set an X-ray irradiation distance 1 to 10 mm to 30 mm in consideration of the intensity of X-ray and the X-ray absorption capacity of the material. In order to avoid ununiformity of a radial spread of the Debye ring 8 due to the difference in angle Ψ between each diffracted X-ray 7 and the normal line of the treating surface 5, the incident X-ray 6 is desirably set parallel to the normal line of the treating surface 5 in such a manner that the angle Ψ becomes constant.

Since the X-ray 7 direction is not consistent with the normal line of the IP two-dimensional detector 3, diffraction angle 2θ should be obtained by the following equation (8):

$$2 θ = 180 - arctan ( s \text{/} l ) \cdot \frac{180}{π} \qquad ( 8 )$$

where s denotes a distance from the center of the Debye ring 8 in radial direction, and I denotes an X-ray irradiation distance.

A strict numerical calculation such as an approximation with a function is needed for obtaining the above-described full width at half maximum B₁ and the integral intensity angular breadth B₂, requiring an analysis feature in the system, not easy to treat. Instead, there is also a simple method that, after the background is subtracted from X-ray diffraction intensity curve, the full width at half maximum B₁ is set to be half the difference Δ2θ in diffraction angles at both ends where the diffraction intensity is 0 (refer also to FIG. 4 about Δ2θ).

FIG. 5 is a schematic view showing the radial width (a difference between the outer and inner radii) S_{R} of a Debye ring 8. The radial width S_{R} of the Debye ring 8, the given X-ray irradiation distance l and Δ2θ have a linear relation expressed in the following equation (9):

$${S}_{R} = ( \frac{l}{{cos}^{2} 2 {θ}_{Ψ}} ) \cdot Δ2θ ≅ 2 ( \frac{l}{{cos}^{2} 2 {θ}_{Ψ}} ) \cdot {B}_{1} . \qquad ( 9 )$$

Therefore, B₁ can be estimated using the equation (9) by the measurement of the radial width S_{R} of the Debye ring 8. The radial width S_{R} of the Debye ring 8 can be obtained based on the contrast and the difference in blackening between the Debye ring 8 and the background, which has been recorded in the imaging plate.

The present method constructs the correlation between at least any one of the full width at the half maximum B₁, the integral intensity angular breadth B₂ and the radial width S_{R} of two-dimensional diffraction patterns, which are X-ray diffraction parameters, and the local misorientation parameter GROD of EBSD method, and indirectly measures these X-ray diffraction parameters, thereby realizing nondestructive evaluation of plastic strain of the treated surface layer of the measurement object.

Explanation of the procedures returns to the description of Step 2 in FIG. 1.

At Step 2-4, the test specimen subjected to the X-ray diffraction is cut to expose its cross section by a method such as electric discharge machining. After the cross section is mirror finished, an EBSD measurement is performed on the section to obtain the local misorientation parameter GROD, thereby creating a GROD distribution map. In the case of a general metal, a penetration depth is a 10 μm or a little more than 10 μm in the X-ray diffraction method. Therefore, the average value of GROD is obtained with respect to a region up to a depth d=10 μm or so from the surface of an EBSD measurement region. Thereafter, the correlation between the X-ray diffraction parameters and GROD obtained at the same test specimen is obtained by executing an approximation with a function GROD=h(x) (where x is B₁, B₂ or S_{R}) by the method of least squares to thereby create a correlation diagram (B₁-GROD diagram, B₂-GROD diagram or S_{R} GROD diagram). That is, the correlation GROD=h₁(B₁) between the X-ray diffraction parameter B₁ and GROD is represented by the B₁-GROD diagram, the correlation GROD=h₂ (B₂) between the X-ray diffraction parameter B₂ and GROD is represented by the B₂-GROD diagram, and the correlation GROD=h₃ (S_{R}) between the X-ray diffraction parameter S_{R} and GROD is represented by the S_{R} GROD diagram.

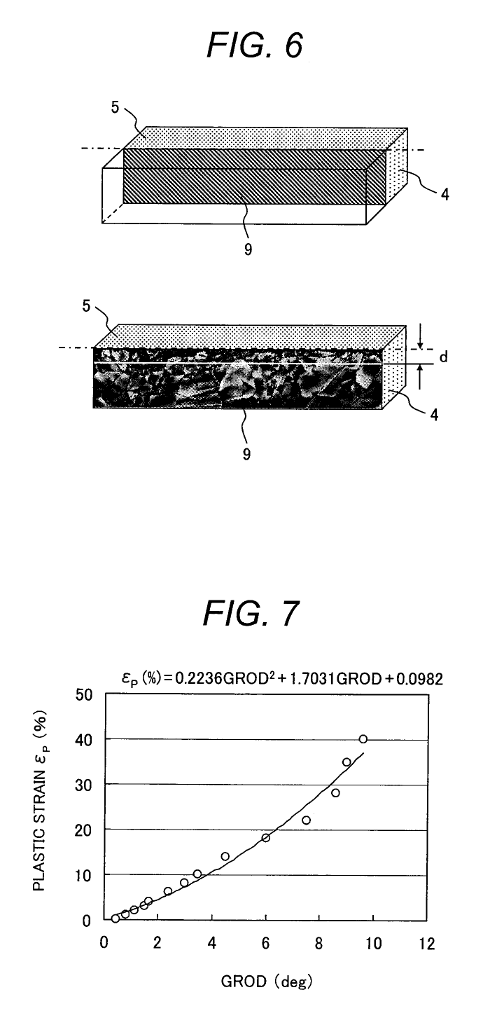

FIG. 6 is a schematic view illustrating an EBSD measurement region of the measurement object. The upper illustration of FIG. 6 shows the treating surface 5 of the object 4 (test specimen) to be measured, shown in FIGS. 3 and 4, and its corresponding EBSD analysis plane 9. The EBSD analysis plane 9 is an internal section perpendicular to the treating surface 5. The lower illustration of FIG. 6 is a GROD distribution map at the EBSD analysis plane 9. In the present embodiment, the average value of GROD is obtained with respect to a region up to a depth d=10 μm or so from the treating surface 5. In the lower illustration of FIG. 6, grayscale picture is drawn in the EBSD analysis plane 9 according to the obtained average value of GROD.

1.3 Expressing a Relation Between an X-Ray Diffraction Parameter and Plastic Strain with a Function

At Step 3 in FIG. 1, a functional relation ε_{P}=f(x) (where x is B₁, B₂ or S_{R}) between plastic strain ε_{R} and the X-ray diffraction parameter is obtained from ε_{P}=g(GROD) obtained at Step 1 (expressing a relation between GROD and plastic strain ε_{P} with a function) and from GROD=h(x) (where x is B₁, B₂ or S_{R}) obtained at Step 2 (expressing a relation between the X-ray diffraction parameter (B₁, B₂ or S_{R}) and GROD with a function). A master diagram indicative of the relation between each X-ray diffraction parameter and plastic strain ε_{P} can be created based on the relation ε_{R}=f(x) (where x is B₁, B₂ or S_{R}) between plastic strain ε_{P} and the X-ray diffraction parameter. That is, the correlation ε_{P}=f₁ (B₁) between the X-ray diffraction parameter B₁ and plastic strain ε_{P} is represented by the B₁-ε_{P} diagram. The correlation ε_{P}=f₂(B₂) between the X-ray diffraction parameter B₂ and plastic strain ε_{R} is represented by the B₂-ε_{P} diagram. The correlation ε_{P}=f₃(S_{R}) between the X-ray diffraction parameter S_{R} and plastic strain ε_{P} is represented by the S_{R}-ε_{P} diagram.

2. Evaluation of Plastic Strain (Actual Measurement)

The B₁-ε_{R} diagram, B₂-ε_{P} diagram or S_{R}-ε_{P} diagram obtained in the above procedures is assumed to be the master diagram. An X-ray diffraction parameter (B₁, B₂ or S_{R}) obtained by measuring the measurement object are plotted on the master diagram, thereby enabling non-destructive evaluation of plastic strain ε_{P} of the object.

As shown at Steps 41 through 43 in FIG. 1, the actual measurement and evaluation of plastic strain are carried out in the following manner.

At Step 41, X-ray diffraction is measured at the surface of an actual measurement object.

At Step 42, an X-ray diffraction parameter is obtained from the measurement result of the X-ray diffraction of the object by an analysis program of the image analyzing device. At least any one of the full width at half maximum B₁, the integral intensity angular breadth B₂ and the radial width S_{R} of two-dimensional diffraction patterns is obtained as the X-ray diffraction parameter.

At Step 43, plastic strain ε_{P} of the measurement object is evaluated using the X-ray diffraction parameter (at least any one of the full width at half maximum B₁, the integral intensity angular breadth B₂ and the radial width S_{R} of two-dimensional diffraction patterns) obtained at Step 42 and the master diagram (B₁-ε_{P} diagram, B₂-ε_{P} diagram or S_{R}-ε_{P} diagram) created at Steps 1 through 3. That is, in the present embodiment, the X-ray diffraction parameter obtained at Step 42 is plotted on a master diagram (which shows the relation between the X-ray diffraction parameter and plastic strain ε_{P}) of the object to thereby enable non-destructive evaluation of plastic strain ε_{P} of the treated surface layer of the object.

It is desirable that, in order to take into consideration variations of measurement spots, test specimens and the object are measured at plural spots thereof at the EBSD analysis and the measurement of the X-ray diffraction parameters upon the creation of the master diagram and the actual measurement of the object, and the average value of measured values and a range of variations thereof are reflected on the result of evaluation.

3. Procedure for Creating Master Diagram (Part 2)

Another procedure for creating a master diagram (procedure for expressing a correlation between an X-ray diffraction parameter and plastic strain with a function) will be explained.

As an average misorientation parameter of a measurement region, GROD is hardly affected by the direction of plastic strain. However, a great deal of time is required for creating the master diagram because works such as a polishing operation and a sample production are performed upon the EBSD analysis in the above-described “Procedure for Creating Master Diagram (Part 1)” The present inventors et al have developed a simple method for creating a master diagram, which can obtain a correlation between the X-ray diffraction parameters and plastic strain in a shorter period of time without performing the EBSD analysis.

This method for creating the master diagram will be explained below. A specimen for a tensile test is produced from a material similar to the measurement object and a tensile test is conducted thereon. After plastic strain ε_{P} has been introduced by strain control in the tensile test, X-ray diffraction intensity and diffraction angle 2θ are measured at the surface of test specimens by the X-ray detector. The full width at half maximum B₁ or the integral intensity angular breadth B₂ is obtained in the same method as described in the “1.2 Expressing a Relation between an X-ray Diffraction Parameter and GROD with a Function.” When X-ray diffraction intensity is measured by the two-dimensional detector, the radial width S_{R} of two-dimensional diffraction patterns can also be obtained. The correlations between these X-ray diffraction parameters and plastic strain ε_{P} are approximately expressed with functions by the method of least squares, thereby resulting in the creation of a master diagram.

After the creation of the master diagram, plastic strain ε_{P} of the object can be non-constructively evaluated in the same method as described in the “2. Evaluation of Plastic Strain (Actual Measurement).”

This simple method for creating the master diagram does not need to use an expensive electron backscattering diffraction device and can greatly shorten the time to create the master diagram, whereby higher general versatility is expected. However, there is a case where the X-ray diffraction parameter differs depending on the direction of the measurement because the plastic deformation has an orientation in a uniaxial tensile test. In addition, the treating history of the surface of test specimens also affects X-ray diffraction parameters. It is therefore preferable that, when the present method is used, the surface layer is removed by a few tens to a few hundreds of μm by, for example, electrolytic polishing, and X-ray diffraction is measured in plural directions to thereby obtain the average values of X-ray diffraction parameters.

4. Evaluation System

4.1 X-Ray Detector

A zero-dimensional scintillation counter or a one-dimensional position sensitive detector can be employed as an X-ray detector of the X-ray diffraction device for a general structural material like carbon steel, which possesses fine grains with no crystal texture. In this case, plastic strain ε_{P} is evaluated by the full width at half maximum B₁ and the integral intensity angular breadth B₂. A scintillation proportional counter can be used as the zero-dimensional scintillation counter, for example.

For a material like a weld metal, which has coarse and textured crystals, it is desirable to use a two-dimensional detector capable of obtaining omnidirectional X-ray diffraction information in one measurement because each diffracted X-ray to be detected has a directional property. A two-dimensional detector of an imaging plate type can be used as the two-dimensional detector, for example.

4.2 Evaluation Criterion of Plastic Strain

One of the features of the present embodiments is that a master diagram is created in which the relation between each X-ray diffraction parameter and plastic strain is expressed with a function for plural types of materials, the master diagram about these materials being used for an evaluation criterion of the present evaluation system. The present evaluation system is a system wherein plastic strain is evaluated by calculating each X-ray diffraction parameter from an X-ray diffraction pattern by a numerical calculation, and by using a master diagram made in advance about a corresponding material, i.e., by substituting the X-ray diffraction parameter into a function indicative of the relation between the X-ray diffraction parameter and plastic strain. Implementing general versatility of the system needs accumulation of evaluation criteria about a wide range of material quality. It is therefore desirable that a diagram (master diagram) in which the relation between each X-ray diffraction parameter and plastic strain of each material is expressed with a function is prepared in advance as a database of the present evaluation system, using the above-described method, for at least each material required to be evaluated.

5. Availability

The evaluation system and method of plastic strain of the present embodiments non-constructively can evaluate plastic strain formed in a treated surface layer of the measurement object by using, as a parameter, at least any one of the full width at half maximum B₁, the integral intensity angular breadth B₂ and the radial width S_{R} of two-dimensional diffraction patterns, which are X-ray diffraction parameters. Therefore, the evaluation system and method of plastic strain can be applied to actual structures and completed products in which destructive sampling is impossible. Plastic strain can be evaluated simply by substituting a measured X-ray diffraction parameter into a function indicative of the relation between the X-ray diffraction parameter and plastic strain, which has been prepared in advance as an evaluation criterion. Therefore, the prompt evaluation of plastic strain at a measurement place is expected, and the evaluation system and method can be used even for a large amount of measurement considering variations of mass-produced products.

### First Embodiment

In the present embodiment, a master diagram was created using the full width at half maximum B₁ among the X-ray diffraction parameters which are the full width at half maximum B₁, the integral intensity angular breadth B₂ and radial width S_{R} of two-dimensional diffraction patterns. In the evaluation of plastic strain (actual measurement), the radial width S_{R} of an X-ray diffraction ring (Debye ring) was measured using an IP two-dimensional detector. The full width at half maximum B₁ was obtained from the measured width S_{R}, and plastic strain ε_{P} was obtained from the full width at half maximum B₁ and the master diagram.

Upon creation of the master diagram, plural test specimens were produced from the austenitic stainless steel SUS316L, and a tensile test was conducted thereon in accordance with the standard of JIS Z 2241 (1998) to introduce plastic strains of 0%, 1%, 2%, 3%, 4%, 6%, 8%, 10%, 14%, 18%, 22%, 28%, 35% and 40%, respectively. After the tensile test, an EBSD analysis was conducted in a 1 mm×1 mm region of a parallel part of each test specimen to calculate an average value of GROD in the measurement region. The EBSD analysis was conducted using the crystal analysis tool OIM for a scanning electron microscope, which has been manufactured by TSL solutions k.k. The OIM was attached to the scanning electron microscope S-4300SE manufactured by Hitachi High-Technologies Corporation. The measurement step was set to 2 μm.

FIG. 7 is a correlation diagram (GROD-ε_{P} diagram) obtained in the present embodiment between GROD (average value of GROD of measurement region) and plastic strain ε_{P}. A function indicative of the relation between GROD and plastic strain ε_{P} was approximately represented as ε_{P} (%)=0.2236GROD²+1.7031GROD+0.0982 by the method of least squares.

Plural plates of test specimens of 100 mm×60 mm×100 mm were produced from the same test specimen. The surfaces of the respective test specimens were treated under different treating conditions shown in Table 1. Thereafter, X-ray diffraction intensity and diffraction angle from the surface of each test specimen were measured by the measuring method shown in FIG. 3 to obtain the full width at half maximum B₁. The X-ray tube was Mn and its output was 1.5 mA at 17 kV. The scanning speed of the detector was 1 (deg)/min, and the sampling width was 0.1 (deg). A diffraction plane was set to a (311) plane high in diffraction intensity.

After the measurement of the X-ray diffraction, test specimens was cut along the center line in the longitudinal direction thereof to select three or more regions of 200 μm×10 μm up to 10 μm depth under the surface. An average value of GROD in the measurement region was analyzed by EBSD method. A correlation diagram (B₁-GROD diagram) between the full width at half maximum B₁ and GROD was obtained from the obtained full width at half maximum B₁ and GROD (average value of GROD of all measurement regions). The relation between the full width at half maximum B₁ and GROD was approximately represented as GROD (deg)=1.7327B₁ (deg)+0.0472.

The relation between plastic strain ε_{P} and full width at half maximum B₁ was obtained as ε_{P} (%)=0.6713B₁² 2.9875B₁+0.1791 from the above results, i.e., the relation between GROD and plastic strain ε_{P} and the relation between the full width at half maximum B₁ and GROD, to create a master diagram (master diagram showing the relation between the full width at half maximum B₁ and plastic strain ε_{P}) shown in FIG. 9. As will be described later, plastic strain ε_{P} can be obtained from the full width at half maximum B₁ using the master diagram shown in FIG. 9.

TABLE 1

| Material | SUS316L | | | | |
|---|---|---|---|---|---|
| Size of test | 100 mm × 60 mm × 10 mm | | | | |
| speciment | | | | | |
| Treating | Electrolytic | Emery | Flapper | Grinder | Machining |
| conditions | polishing | paper#2000 | foil | treating | |
| | | | treating | | |

After the creation of the master diagram, plastic strain ε_{P} was obtained, as the actual measurement, using a steel plate that was the same material as test specimens and had been cold-rolled at a rolling rate of 15%.

First, a two-dimensional X-ray diffraction ring (Debye ring) of this steel plate was obtained using the IP two-dimensional detector by the measuring method shown in FIG. 4. An X-ray tube was Mn and the output was 1.5 mA at 17 kV. A diffraction plane was set to a (311) plane, the peak position of diffraction angle being set to 2θ_{Ψ}=152.28 (deg), an X-ray irradiation distance l being set to 1=20 mm, and the time for irradiation being set to 5 min. An X-ray diffraction pattern was read from the imaging plate after the irradiation test by the image analyzing device Typhoon FLA9000 manufactured by GE Healthcare Japan Corporation. The resolution was 25 μm/Pixel.

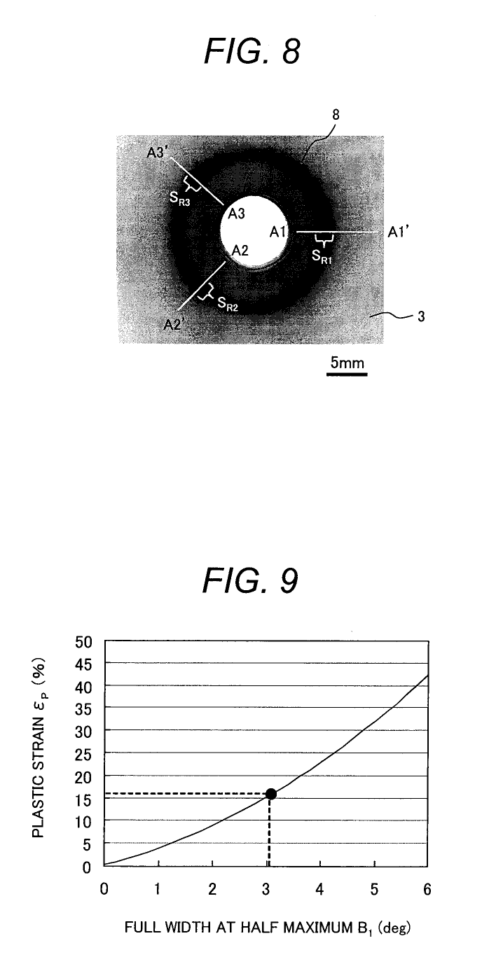

FIG. 8 is a photograph of a Debye ring 8, which has been recorded on the imaging plate. The radial width (spread of the line profile) S_{R} was measured with respect to three points at which center angle intervals of the Debye ring 8 were about 120 (deg), and was substituted into the equation (9) to calculate an approximate value of the full width at half maximum B₁. The radial width of the Debye ring, which is taken along a line profile A1-A1′, is denoted as S_{R1}. The radial width of the Debye ring, which is taken along a line profile A2-A2′, is denoted as S_{R2}. The radial width of the Debye ring, which is taken along a line profile A3-A3′, is denoted as S_{R3}.

Table 2 shows the radial widths S_{R} of respective line profiles and the calculation results of the full widths at half maximum B₁. The average value 3.087 (deg) of the full widths at half maximum B₁ of these line profiles was substituted into the above-described function ε_{P} (%)=0.6713B₁²+2.9875B₁+0.1791 indicative of the relation between plastic strain ε_{P} and the full width at half maximum B₁ to thereby evaluate plastic strain ε_{P}. The evaluation result of plastic strain ε_{P} was ε_{P}=15.8%.

FIG. 9 is the above-described master diagram (master diagram showing the relation between the full width at half maximum B₁ and plastic strain ε_{P}). The relation between the full width at half maximum B₁ and plastic strain £_{P} is expressed by ε_{P} (%)=0.6713B₁²+2.9875B₁+0.1791. The average value 3.087 (deg) of the obtained full widths at half maximum B₁ is also plotted in FIG. 9. FIG. 9 shows that plastic strain ε_{P} corresponding to the full width at half maximum B₁ of 3.087 (deg) is about 15%. Accordingly, plastic strain ε_{P} of the object (steel plate cold-rolled at the rolling rate of 15%) was evaluated as a value close to the rolling rate of 15%. Thus, the validity of the evaluation system and method for plastic strain according to the present embodiment was verified.

TABLE 2

| Line profile | A1-A1′ | A2-A2′ | A3-A3′ |
|---|---|---|---|
| Radial width S_{R} (μm) | 3250 | 2478 | 2522 |
| Full width at half maximum B₁ (deg) | 3.648 | 2.781 | 2.831 |
| Average value of full widths at half | | 3.087 | |
| maximum B₁ (deg) | | | |

### Second Embodiment

The present embodiment is an example for creating a master diagram by the method described in the “3. Procedure for Creating Master Diagram (Part 2).”

In the present embodiment, plural specimens for a tensile test were produced from the austenitic stainless steel SUS316L, and a tensile test was conducted thereon in accordance with the standard of JIS Z 2241 (1998) to introduce plastic strains ε_{P} of 0%, 2%, 4%, 6%, 8%, 10%, 15% and 20%, respectively. Thereafter, a surface layer of about 50 μm was removed by electrolytic polishing. In two directions perpendicular and parallel to a tensile direction, X-ray diffraction intensity and diffraction angle 2θ were measured by a zero-dimensional scintillation counter and a goniometer to obtain X-ray diffraction intensity curve. Further, the full width at half maximum B₁ was obtained by the equations (1), (4) and (7).

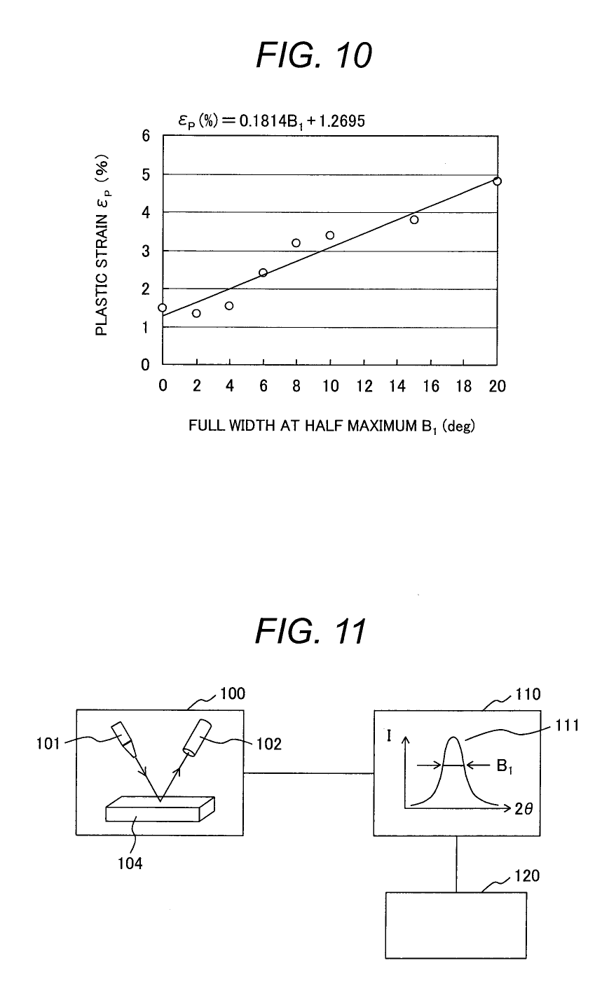

FIG. 10 is a master diagram showing the relation between the full width at half maximum B₁ and plastic strain ε_{P} in the second embodiment. The full width at half maximum B₁ is an average value of full widths at half maximum B₁ obtained in the two directions perpendicular and parallel to the tensile direction. The relation between the full width at half maximum B₁ and plastic strain ε_{P} is expressed in ε_{P} (%)=0.1814B₁+1.2695 by linear approximation.

Thus, a master diagram showing the relation between each X-ray diffraction parameter and plastic strain can be obtained even from a uniaxial tensile test. Even in the present embodiment, as same as in the first embodiment, a treated surface layer of the measurement object can be non-destructively evaluated from the master diagram based on each X-ray diffraction parameter obtained from the measurement object.

The evaluation system and evaluation method of plastic strain according to the present invention can be easily utilized, for example, as a part of the management of surface finishing quality of in-service structural components and finished products where destructive sampling is unavailable, or as a part of the evaluation method for stress corrosion cracking (SCC) susceptibility in stress corrosion environments.

What is claimed is:

1. An evaluation system of plastic strain comprising:
an X-ray diffraction device for irradiating a surface of a measurement object with X-ray and measuring diffraction angle and X-ray diffraction intensity; and
an image analyzing device for generating an X-ray diffraction intensity curve based on the measured diffraction angle and X-ray diffraction intensity,
wherein the image analyzing device is implanted with a data base, which can be obtained in advance from test specimens made of the same material of the measurement object, for establishing at least one of two relations between full width at half maximum of the X-ray diffraction intensity curve and plastic strain, and between integral intensity angular breadth of the X-ray diffraction intensity curve and the plastic strain,
wherein the image analyzing device evaluates plastic strain of the measurement object based on at least one of the two diffraction parameters of the full width at half maximum and the integral intensity angular breadth of an X-ray diffraction intensity curve corresponding to the implanted data base.

2. An evaluation system of plastic strain comprising:
an X-ray diffraction device for irradiating a surface of a measurement object and recording two-dimensional diffraction patterns with a two-dimensional detector; and
an image analyzing device for generating an X-ray diffraction intensity curve based on diffraction angle and X-ray diffraction intensity in radial direction from incident X-ray center of the two-dimensional diffraction patterns,
wherein the image analyzing device is implanted with a data base, which can be obtained in advance from test specimens made of the same material of the measurement object, for establishing at least one of the three relations between full width at half maximum of the X-ray diffraction intensity curve and plastic strain, between integral intensity angular breadth of the X-ray diffraction intensity curve and the plastic strain, and between radial width of the two-dimensional diffraction patterns and the plastic strain,
wherein the image analyzing device evaluates plastic strain of the measurement object based on at least one of the three diffraction parameters of the full width at half maximum, the integral intensity angular breadth of an X-ray diffraction intensity curve, and the radial width of two-dimensional diffraction patterns corresponding to the implanted data base.

3. The evaluation system of plastic strain according to claim 1, further comprising:
an electron backscattering diffraction device for obtaining local misorientation parameter GROD,
wherein the image analyzing device is implanted with a data base, which can be obtained in advance from test specimens made of the same material of the measurement object, for establishing a relation between GROD and plastic strain,
wherein the image analyzing device is implanted with a data base, which can be obtained in advance from test specimens made of the same material of the measurement object, for establishing at least one of the two relations between the full width at half maximum of the X-ray diffraction intensity curve and GROD, and between the integral intensity angular breadth of the X-ray diffraction intensity curve and GROD,
wherein the image analyzing device derives, from the implanted data base, at least one of the two relations between the full width at half maximum of the X-ray diffraction intensity curve and the plastic strain, and between the integral intensity angular breadth of the X-ray diffraction intensity curve and the plastic strain, and
wherein the image analyzing device evaluates plastic strain of the measurement object based on at least one of the two diffraction parameters of the full width at half maximum and the integral intensity angular breadth of an X-ray diffraction intensity curve of the object corresponding to the relations between these parameters and the plastic strain.

4. The evaluation system of plastic strain according to claim 2, further comprising:
an electron backscattering diffraction device for obtaining local misorientation parameter GROD,
wherein the image analyzing device is implanted with a data base, which can be obtained in advance from test specimens made of the same material of the measurement object, for establishing a relation between GROD and plastic strain,
wherein the image analyzing device is implanted with a data base, which can be obtained in advance from test specimens made of the same material of the measurement object, for establishing at least one of three relations between the full width at half maximum of the X-ray diffraction intensity curve and GROD, between the integral intensity angular breadth of the X-ray diffraction intensity curve and GROD, and between the radial width of the two-dimensional diffraction patterns and GROD,
wherein the image analyzing device derives, from the implanted data base, at least one of the three relations between the full width at half maximum of the X-ray diffraction intensity curve and the plastic strain, between the integral intensity angular breadth of the X-ray diffraction intensity curve and the plastic strain, and between the radial width of the two-dimensional diffraction patterns and the plastic strain, and
wherein the image analyzing device evaluates plastic strain of the measurement object based on at least one of the three diffraction parameters of full width at half maximum of an X-ray diffraction intensity curve of the object, integral intensity angular breadth of the X-ray diffraction intensity curve of the object, and a width of two-dimensional diffraction patterns corresponding to the relations between these parameters and the plastic strain.

5. The evaluation system of plastic strain according to claim 1,
wherein the image analyzing device represents at least one of the two relations between the full width at half maximum of the X-ray diffraction intensity curve and the plastic strain and between the integral intensity angular breadth of the X-ray diffraction intensity curve and the plastic strain as a function or a diagram.

6. The evaluation system of plastic strain according to claim 2,
wherein the image analyzing device represents at least one of the three relations between the full width at half maximum of the X-ray diffraction intensity curve and the plastic strain, between the integral intensity angular breadth of the X-ray diffraction intensity curve and the plastic strain, and between the radial width of the two-dimensional diffraction patterns and the plastic strain as a function or a diagram.

7. The evaluation system of plastic strain according to claim 3,
wherein the image analyzing device represents the relation between GROD and the plastic strain as a function or a diagram,
wherein the image analyzing device represents at least one of the two relations between the full width at half maximum of the X-ray diffraction intensity curve and GROD, and between the integral intensity angular breadth of the X-ray diffraction intensity curve and GROD as a function or a diagram, and
wherein the image analyzing device represents at least one of the two relations between the full width at half maximum of the X-ray diffraction intensity curve and the plastic strain, and between the integral intensity angular breadth of the X-ray diffraction intensity curve and the plastic strain as a function or a diagram.

8. The evaluation system of plastic strain according to claim 4,
wherein the image analyzing device represents the relation between GROD and the plastic strain as a function or a diagram,
wherein the image analyzing device represents at least one of the three relations between the full width at half maximum of the X-ray diffraction intensity curve and GROD, between the integral intensity angular breadth of the X-ray diffraction intensity curve and GROD, and between the radial width of the two-dimensional diffraction patterns and GROD as a function or a diagram, and
wherein the image analyzing device represents at least one of the three relations between the full width at half maximum of the X-ray diffraction intensity curve and the plastic strain, between the integral intensity angular breadth of the X-ray diffraction intensity curve and the plastic strain, and between the radial width of the two-dimensional diffraction patterns and the plastic strain as a function or a diagram.

9. An evaluation method of plastic strain comprising the steps of:
irradiating a surface of a measurement object with X-ray and obtaining an X-ray diffraction intensity curve; and
obtaining in advance such a data base from test specimens made of the same material of the measurement object that establishes at least one of two relations between full width at half maximum of the X-ray diffraction intensity curve and plastic strain, and between integral intensity angular breadth of the X-ray diffraction intensity curve and the plastic strain,
evaluating plastic strain of the measurement object based on at least one of the two diffraction parameters of the full width at half maximum and the integral intensity angular breadth of the X-ray diffraction intensity curve corresponding to the two relations.

10. An evaluation method of plastic strain comprising the steps of:
irradiating a surface of a measurement object with X-ray and recording two-dimensional diffraction patterns with a two-dimensional detector; and
obtaining in advance such a data base from test specimens made of the same material of the measurement object that establishes at least one of three relations between full width at half maximum of the X-ray diffraction intensity curve and plastic strain, between integral intensity angular breadth of the X-ray diffraction intensity curve and the plastic strain, and between radial width of the two-dimensional diffraction patterns and the plastic strain; and
evaluating plastic strain of the measurement object from at least one of the three parameters of the full width at half maximum of the X-ray diffraction intensity curve, the integral intensity angular breadth of the X-ray diffraction intensity curve, and the radial width of the two-dimensional diffraction patterns corresponding to the data base.

11. The evaluation method of plastic strain according to claim 9, further comprising the steps of:
obtaining in advance such a data base from the test specimens made of the same material of the measurement object that establishes the relation between local misorientation parameter GROD and the plastic strain;
obtaining in advance such a data base from the test specimens made of the same material of the measurement object that establishes at least one of the two relations between the full width at half maximum of the X-ray diffraction intensity curve and GROD, and between the integral intensity angular breadth of the X-ray diffraction intensity curve and GROD;
deriving, from these data, at least one of the two relations between the full width at half maximum of the X-ray diffraction intensity curve and the plastic strain, and between the integral intensity angular breadth of the X-ray diffraction intensity curve and the plastic strain; and
evaluating plastic strain of the measurement object based on at least one of the two diffraction parameters of the full width at half maximum and the integral intensity angular breadth of X-ray diffraction intensity corresponding to the relations described above.

12. The evaluation method of plastic strain according to claim 10, further comprising the steps of:
obtaining in advance such a data base from the test specimens made of the same material of the measurement object that establishes the relation between local misorientation parameter GROD and the plastic strain;
obtaining in advance such a data base from the test specimens made of the same material of the measurement object that establishes at least one of the three relations between the full width at half maximum of the X-ray diffraction intensity curve and GROD, between the integral intensity angular breadth of the X-ray diffraction intensity curve and GROD, and between the radial width of the two-dimensional diffraction patterns and GROD;
deriving, from these data, at least one of the three relations between the full width at half maximum of the X-ray diffraction intensity curve and the plastic strain, between the integral intensity angular breadth of the X-ray diffraction intensity curve and the plastic strain, and between the radial width of the two-dimensional diffraction patterns and the plastic strain; and
evaluating plastic strain of the measurement object from at least one of the three diffraction parameters of the full width at half maximum of X-ray diffraction intensity curve, the integral intensity angular breadth of the X-ray diffraction intensity curve, and the radial width of two-dimensional diffraction patterns corresponding to the relations described above.

13. The evaluation method of plastic strain according to claim 9, further comprising the step of:
representing at least one of the two relations between the full width at half maximum of the X-ray diffraction intensity curve and the plastic strain, and between the integral intensity angular breadth of the X-ray diffraction intensity curve and the plastic strain as a function or a diagram.

14. The evaluation method of plastic strain according to claim 10, further comprising the step of:
representing at least one of the three relations between the full width at half maximum of the X-ray diffraction intensity curve and the plastic strain, between the integral intensity angular breadth of the X-ray diffraction intensity curve and the plastic strain, and between the radial width of the two-dimensional diffraction patterns and the plastic strain as a function or a diagram.

15. The evaluation method of plastic strain according to claim 11, further comprising the steps of:
representing the relation between GROD and the plastic strain as a function or a diagram;
representing at least one of the two relations between the full width at half maximum of the X-ray diffraction intensity curve and GROD, and between the integral intensity angular breadth of the X-ray diffraction intensity curve and GROD as a function or a diagram; and
representing at least one of the two relations between the full width at half maximum of the X-ray diffraction intensity curve and the plastic strain, and between the integral intensity angular breadth of the X-ray diffraction intensity curve and the plastic strain as a function or a diagram.

16. The evaluation method of plastic strain according to claim 12, further comprising the steps of:
representing the relation between GROD and the plastic strain as a function or a diagram;
representing at least one of the three relations between the full width at half maximum of the X-ray diffraction intensity curve and GROD, between the integral intensity angular breadth of the X-ray diffraction intensity curve and GROD, and between the radial width of the two-dimensional diffraction patterns and GROD as a function or a diagram; and
representing at least one of the three relations between the full width at half maximum of the X-ray diffraction intensity curve and the plastic strain, between the integral intensity angular breadth of the X-ray diffraction intensity curve and the plastic strain, and between the radial width of the two-dimensional diffraction patterns and the plastic strain as a function or a diagram.
